(19) United States
(12) Patent Application Publication
(10) Pub. No.: US 2006/0123387 A1
(43) Pub. Date: Jun. 8, 2006

(54) Apparatus and method for producing application software for streaming service and system and method for providing software streaming service with network fault tolerance

(75) Inventors: Jeong Min Shim, Daejon (KR); Won Young Kim, Daejon (KR); Wan Choi, Daejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/088,962

(22) Filed: Mar. 24, 2005

(30) Foreign Application Priority Data
Dec. 7, 2004 (KR) 2004-102492

(51) Int. Cl. G06F 9/44

(52) U.S. Cl. 717/100

(57) ABSTRACT

Disclosed are an apparatus and method for producing application software for a streaming service and a system and method for providing a software streaming service with network fault tolerance. The apparatus and method provide an executive code management technique for separating and streaming the software by functions, managing by functions the streamed executive codes from a streaming server, and supporting so that a user can use the application software in a limited manner even if a network fault occurs. The system and method provide a development tool that can develop software for proving the software streaming service that supports the network fault tolerance and streaming by functions. According to the apparatus and method, the software development for providing the software streaming service that supports the network fault tolerance and streaming by functions can easily be performed, and the user can continuously use the software in a limited manner even after the network fault occurs through the server's management of the streamed executive code information.

### BACKGROUND OF THE INVENTION

1. Field of the Invention

The present invention relates generally to a software streaming service, and more particularly, to an apparatus and method for producing application software for a streaming service that can develop application software for creating executive codes suitable for the streaming service. Additionally, the present invention relates generally to a software streaming service, and more particularly to a system and method for providing a software streaming service that enables a client to continuously provide a limited service even after a network fault occurs by managing information of executive codes streamed by functions.

2. Background of the Related Art

The software streaming service is a service that supports client's execution of software existing in a streaming server by streaming executive codes of the software. Unlike multimedia contents that are eventually accessed, some executive codes of software are quite frequently accessed while other executive codes are not accessed at all. Accordingly, for a rapid execution of a program in the streaming service of application software, the executive codes transmitted from the streaming server are temporarily stored in a local computer so as to prevent a duplicate transmission of the execution codes from the streaming server.

Additionally, if a network fault occurs in the software streaming service provided based on a network, it is impossible to receive necessary executive codes from the server. Also, because the executive codes temporarily stored in the local computer merely serve to manage their storage positions for the rapid execution of the program, it is impossible to find out the function of software that can be executed using the executive code temporarily stored in the client. Accordingly, if a network fault occurs, the software being used through the streaming service cannot be used any more.

As described above, in the conventional application software streaming service, the software being installed and used in the existing local computer is divided in a streaming unit to provide the service, and thus the network fault is not under consideration at all. Hereinafter, the existing software streaming service will be explained in more detail.

FIG. 1 is a view schematically illustrating a process of transmitting control data and streaming data related to an application software execution between a streaming server for providing software streaming service and a client. Here, the client indicates a hardwired terminal.

Referring to FIG. 1, the client 110 requests an executive code to the streaming server 120 in order to receive application software through a streaming service. The streaming server 120 searches for an application software executive code 130 requested by the client 110 and transmits the searched application software executive code to the client 110. In this method, the client 110 can use the application software that is not in its own local system through Internet like the application software in its own local system. The client 110 temporarily stores the executive code streamed by the streaming server 120 in its own local computer for the rapid execution of the software, and this executive code is significant as the executive code only while the streaming service is provided. Accordingly, if the network fault occurs, the client cannot receive the executive code from the server 120, and thus the service is intercepted, so that the client cannot use the software.

According to the conventional software streaming service, in order to provide the software through the streaming service instead of installing the software in the local computer, the software is divided and streamed, and the streamed executive codes from the server are temporarily stored in the client for the rapid execution of the software. Accordingly, the conventional software streaming service has focused on the software execution using the streaming technique and the rapid execution of the software. However, the conventional software streaming service has the drawbacks in that because it is not provided with any means for processing against the network fault, which is the limits of the streaming technique based on the network, the providing of the software streaming service may be limited due to the influence of the network.

### SUMMARY OF THE INVENTION

Accordingly, the present invention is directed to an apparatus and method for producing application software for a streaming service and a system and method for providing a software streaming service with network fault tolerance that substantially obviate one or more problems due to limitations and disadvantages of the related art.

It is an object of the present invention to provide an apparatus and method for producing application software for a streaming service that can develop application software for providing software streaming by functions and network fault tolerance.

It is another object of the present invention to provide a system and method for providing a software streaming service that can implement and reconstruct executive codes of application software so as to manage the executive codes by functions at an application software development stage for the streaming service, support the software streaming by functions of the software in the software streaming service by streaming the executive codes by functions from a server, and manage information about the executive codes streamed by functions so that even a limited function of the software can continuously be used even if a network fault occurs.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided an apparatus for producing application software for a streaming service so that the application software implemented using a development language can be used even after a network fault occurs, according to the present invention, which comprises a code analyzer for creating an information file about functions being called when respective functions of the implemented application software are used by extracting a function call relation of the application software, creating a function position information file by extracting information arranged in executive codes of the functions, and creating an executive code information file required when the respective functions are used by integrating the created information, and an application software production tool for the streaming service for producing the application software for the streaming service and the application software executive code information file using a fault-tolerance and functional code-modularity editor that adds and modularizes codes for the fault tolerance and streaming by functions.

In another aspect of the present invention, there is provided a method for producing application software for a streaming service, which comprises the steps of a) adding a code for a fault tolerance service to an implemented application software source code, and modularizing executive codes by functions for transmission of streaming data of the application software, b) creating an information file about functions being called when respective functions of the implemented application software are used by extracting a function call relation of the application software, c) creating a function position information file by extracting information arranged in the executive codes of the functions, and d) creating an executive code information file required when the respective functions of the application software are used by integrating the information obtained at steps b) and c).

In still another aspect of the present invention, there is provided a system for providing a software streaming service, which comprises a streaming server for creating an information file about functions being called when respective functions of the implemented application software are used by extracting a function call relation of the application software, creating a function position information file by extracting information arranged in executive codes of the functions, and storing an executive code information file required when the respective functions are used and obtained by integrating the created information and software produced by adding and modularizing codes for a fault tolerance and streaming by functions, and a client composed of an executive code information management module for recording and managing all the executive codes received from the streaming server and a software streaming control module for controlling the executive code information management module when a network fault occurs.

In still another aspect of the present invention, there is provided a method for providing a software streaming service in a system including a streaming server for creating an information file about functions being called when respective functions of the implemented application software are used by extracting a function call relation of the application software, creating a function position information file by extracting information arranged in executive codes of the functions, and storing an executive code information file required when the respective functions are used and obtained by integrating the created information and software produced by adding and modularizing codes for a fault tolerance and streaming by functions, and a client composed of an executive code information management module for recording and managing all the executive codes received from the streaming server and a software streaming control module for controlling the executive code information management module when a network fault occurs, the method comprising a first step of performing the application software in response to a request for the software streaming service between the client and the streaming server, and a second step of the client continuously performing the application software in a limited manner using the streamed executive code when the network fault occurs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view schematically illustrating a typical process of exchanging a control message and an application software execution code between a client and a streaming server for a software streaming service;

FIG. 2 is a schematic view illustrating the structure of an application software development tool for a streaming service according to the present invention;

FIG. 3 is a flowchart illustrating a process of developing application software for a streaming service according to an embodiment of the present invention;

FIG. 4 is a view illustrating the whole construction and mutual relation between a streaming server and a client for providing a software streaming service according to an embodiment of the present invention;

FIG. 5 is a flowchart illustrating the client's process of executing application software through a streaming service according to an embodiment of the present invention;

FIG. 6 is a flowchart illustrating the operation of the client for processing an executive code request produced from the software being executed through a streaming service according to an embodiment of the present invention; and

FIG. 7 is a flowchart illustrating the client's process of providing a continuous service even after a network fault occurs according to an embodiment of the present invention.

### DETAILED DESCRIPTION OF THE PREFERRED EMBODIMENT

The apparatus and method for producing application software for a streaming service and the system and method for providing a software streaming service with network fault tolerance according to the preferred embodiment of the present invention will now be explained in detail with reference to the accompanying drawings.

The present invention provides a technique for developing software for a streaming service, breaking from the existing method for providing a software streaming service using an install program. According to the present invention, executive codes are streamed by functions, and a client manages the streamed executive code information so that it can continuously use only the streamed function when a network fault occurs.

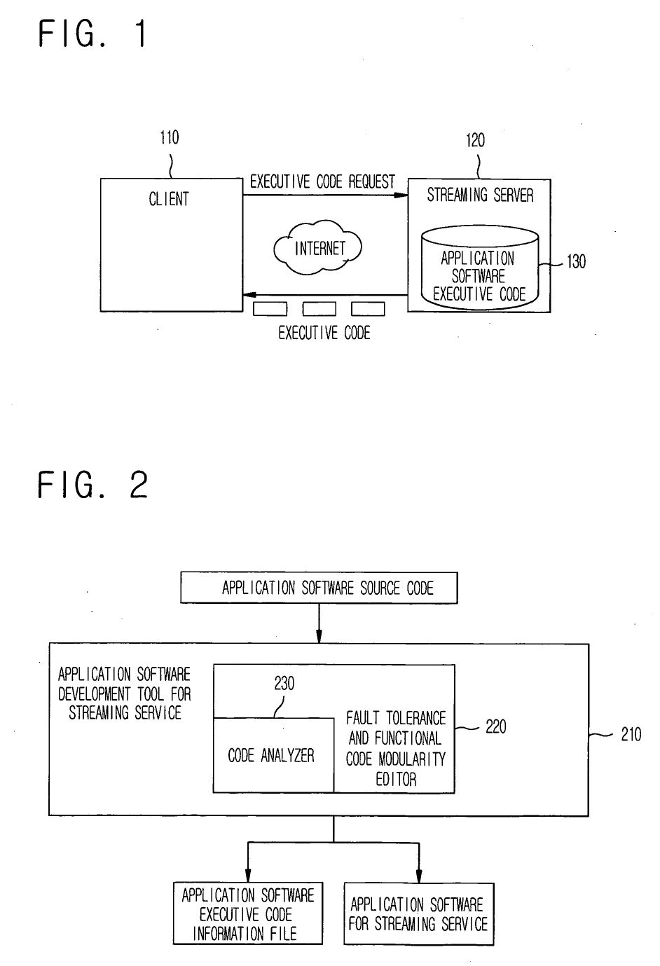

FIG. 2 is a schematic view illustrating the structure of an application software development tool for a streaming service according to the present invention.

Referring to FIG. 2, a developer implements a program using diverse development language in the same manner as the existing application software. The implemented program is developed into application software suitable for the streaming service through an application software development tool 210 for the streaming service. For the fault tolerance and the modularity of executive codes by functions, codes are added through a fault tolerance and functional code modularity editor 220. That is, through the fault tolerance and functional code modularity editor 220, the codes are added and modularized for the fault tolerance and streaming of the executive codes by functions. Additionally, an executive code information file is created through a code analyzer 230 so that the use of the application software is possible after the network fault occurs. Through the application software and the executive code information file made through the application software development tool 210 for the streaming service, a limited service can continuously be provided after the network fault occurs in the software streaming service.

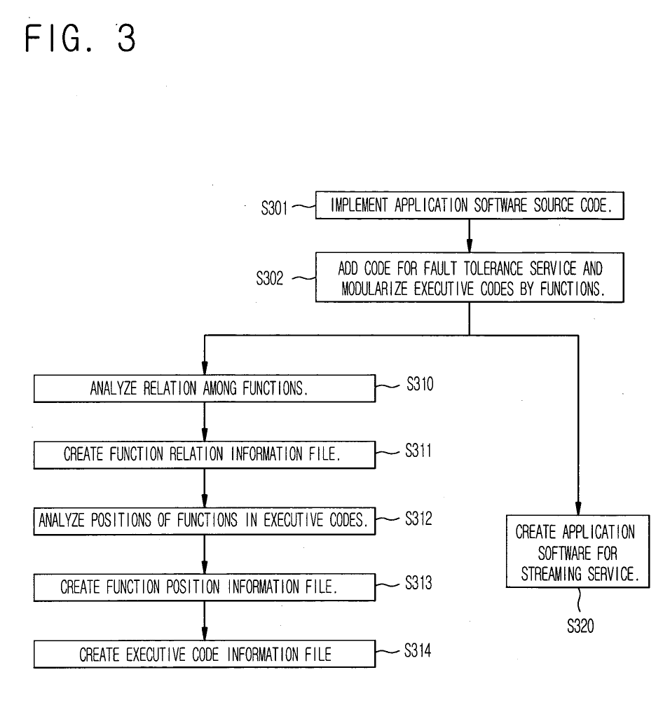

FIG. 3 is a flowchart illustrating a process of developing application software for a streaming service performed by the application software development tool for the streaming service of FIG. 2 according to an embodiment of the present invention. The application software development tool for the streaming service modularizes the executive codes (step S302) by functions in order to add the codes for the fault tolerance service to an application software source code implemented by the developer (step S301) and to efficiently transmit streaming data of the application software. This program to which the code is added becomes the application software used in the actual software streaming service (step S320).

Meanwhile, the streaming data related to the execution should be managed in order to provide a limited service after the network fault occurs, and for this, the code analyzer 230 of the application software development tool for the streaming service creates an information file about functions called when the respective functions are used (step S311) by extracting a function call relation of the implemented program (step S310). Additionally, the code analyzer creates a function position information file (step S313) by extracting information arranged in the executive codes for the respective functions (step S312). Information obtained through the code analyzer 230 illustrated in FIG. 2 are integrated to finally crate an executive code information file required when the respective functions are used (step S314). Through the application software developed through the application software development tool for the streaming service and the executive code information file, the executive codes can efficiently be received from the streaming server, and the software streaming service that have the least effect on the network state can be provided.

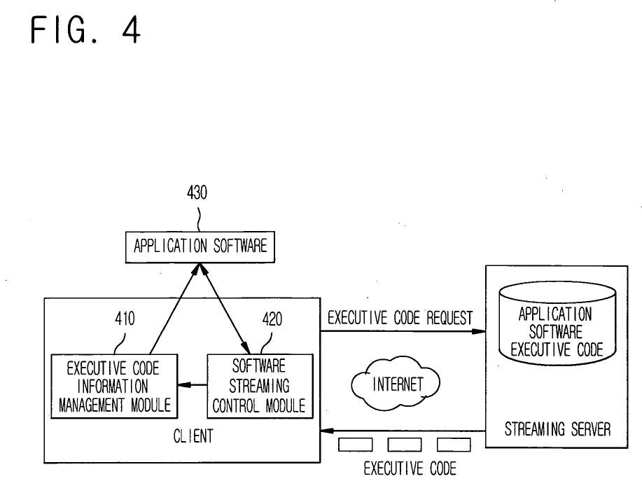

FIG. 4 is a view illustrating the whole construction and a mutual relation between a streaming server and a client for providing a software streaming service with respect to the application software developed through the application software development tool for the streaming service of FIGS. 2 and 3 according to an embodiment of the present invention. All the executive codes received from the streaming server are recorded/managed through an executive code information management module 410. If the network fault occurs, the application software 430 inactivates the executive codes that are not streamed so that functions for the corresponding executive codes cannot be used using the executive code information file under the control of a software streaming control module 420. Users cannot use all the functions for the application software 430, but can continuously use a limited function.

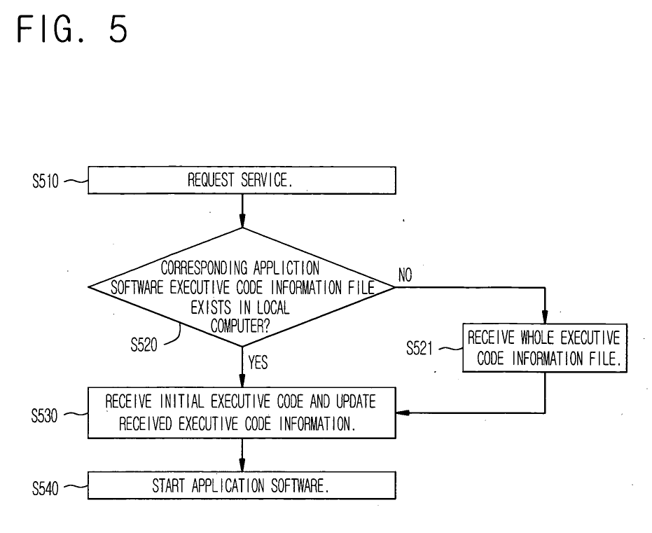

FIG. 5 is a flowchart illustrating the client's process of executing the application software through the streaming service according to the user's service request according to an embodiment of the present invention.

Referring to FIG. 5, if the user requests the service in order to receive the software streaming service (step S510), the client confirms whether the corresponding application software executive code information file exists in the client local system (step S520). If the executive code information file does not exist in the local system, the client receives an information file of the whole executive codes from the streaming server (step S521). After completing the work for the executive code information file, the client receives a code required for an initial execution from the streaming server, and the executive code information management module 410 updates the received executive code information (step S530). The client starts the application software using the received initial executive code, and the user uses the application software through the streaming service.

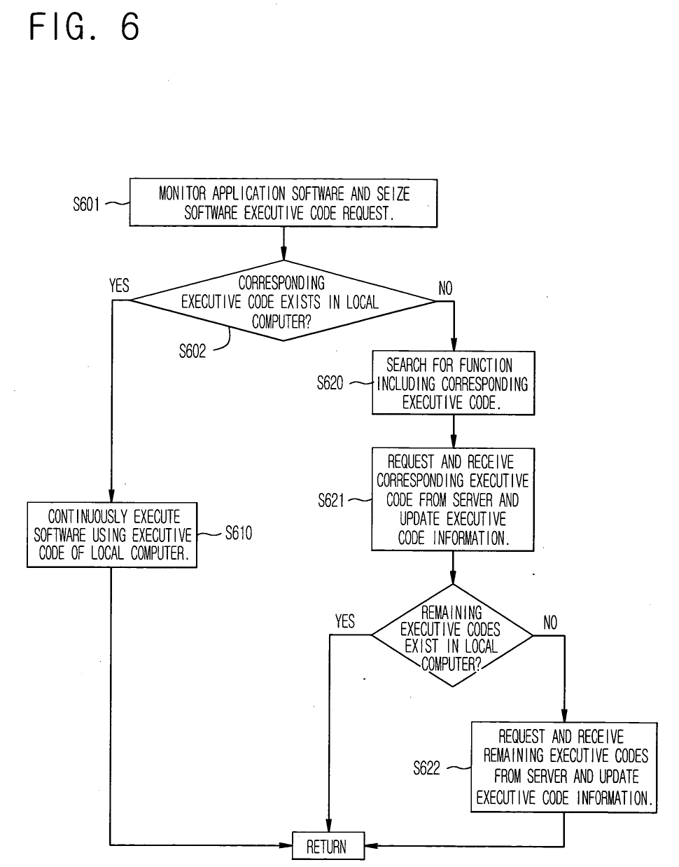

FIG. 6 is a flowchart illustrating the operation of a client for processing an executive code request produced from software being executed through a streaming service according to an embodiment of the present invention.

Referring to FIG. 6, the client monitors an executive code request during the execution of the software (step S601), and judges whether the requested executive code exists in the local computer (step S602). If the executive code exists in the local computer, the client searches for the corresponding executive code and continuously performs the software (step S610). If the requested executive code does not exist in the local computer, the client confirms which function the corresponding executive code belongs to using the whole executive code information for the streaming of the executive codes by functions (step S620), and requests the corresponding executive code to the server. The client then receives the corresponding executive code and executive code information from the server, executes the software, and then updates the executive code information (step S621). Additionally, the client confirms whether the remaining executive codes that do not belong to the corresponding function exist in the local computer, and if not, it requests them to the server. Then, the client receives the executive codes and the executive code information from the server, and updates the executive code information to achieve the streaming by functions (step S622). The above-described process continues until the execution of the software is terminated, and such streaming by functions forms the basis of the continuous use of the limited function of the software if the network fault occurs.

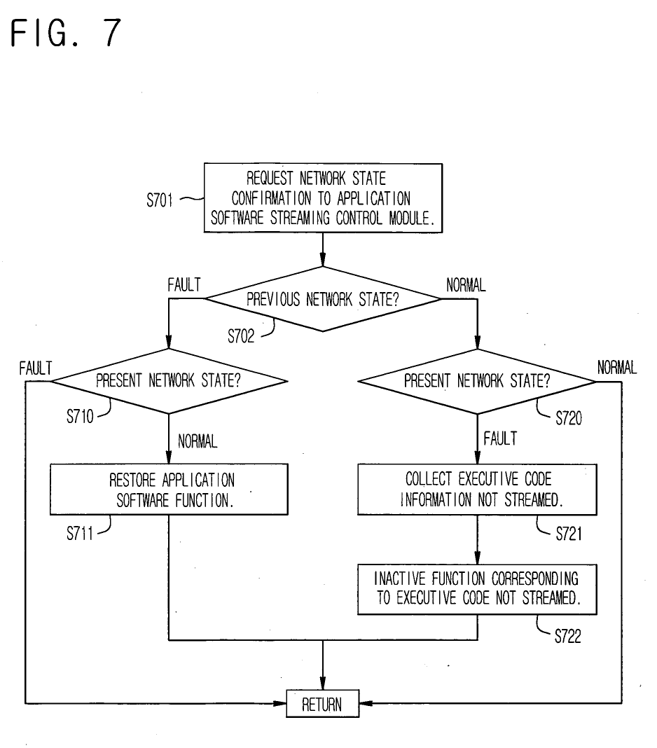

FIG. 7 is a flowchart illustrating the client's process for providing the continuous service according to the network state according to an embodiment of the present invention.

Referring to FIG. 7, the client periodically requests a network state confirmation to the application software streaming control module (step S701). The client maintains the previous network state, and confirms the present network state and the previous network state (steps S702, S710 and S720). If the present network state is equal to the previous network state, the client does not perform any work and terminates the work. If the network state is changed from a normal state to a faulty state, the client collects the information about the executive codes that are not streamed (step S721), and inactivates the functions corresponding to the executive codes that are not streamed, so that the user can continuously use the streamed function only in a limited manner. That is, the user uses the application software using the limited function in the abnormal state of the network, and uses the original functions of the application software in the normal state of the network (step S711). The executive code information management module of the client manages the streamed executive codes, and thus can provide the continuous software streaming service to the user irrespective of the network state.

From the foregoing, it will be apparent that the apparatus and method for producing the application software for the streaming service and the system and method for providing the software streaming service according to the present invention have the advantages that they facilitate the software development for providing the software streaming service that supports the network fault tolerance and streaming by functions, and enable the user to continuously use the software in a limited manner even after the network fault occurs through the server's management of the streamed executive code information.

While the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. An apparatus for producing application software for a streaming service so that the application software implemented using a development language can be used even after a network fault occurs, the apparatus comprising:
a code analyzer for creating an information file about functions being called when respective functions of the implemented application software are used by extracting a function call relation of the application software, creating a function position information file by extracting information arranged in executive codes of the functions, and creating an executive code information file required when the respective functions are used by integrating the created information; and
an application software production tool for the streaming service for producing the application software for the streaming service and the application software executive code information file using a fault-tolerance and functional code-modularity editor that adds and modularizes codes for the fault tolerance and streaming by functions.

2. A method for producing application software for a streaming service, comprising the steps of
a) adding a code for a fault tolerance service to an implemented application software source code, and modularizing executive codes by functions for transmission of streaming data of the application software;
b) creating an information file about functions being called when respective functions of the implemented application software are used by extracting a function call relation of the application software,
c) creating a function position information file by extracting information arranged in the executive codes of the functions; and
d) creating an executive code information file required when the respective functions of the application software are used by integrating the information obtained at steps b) and c).

3. The method as claimed in claim 2, wherein a program to which the code at step a) is added is the application software for the streaming service used in the actual software streaming service.

4. A system for providing a software streaming service, comprising:
a streaming server for creating an information file about functions being called when respective functions of the implemented application software are used by extracting a function call relation of the application software, creating a function position information file by extracting information arranged in executive codes of the functions, and storing an executive code information file required when the respective functions are used and obtained by integrating the created information and software produced by adding and modularizing codes for a fault tolerance and streaming by functions, and
a client composed of an executive code information management module for recording and managing all the executive codes received from the streaming server and a software streaming control module for controlling the executive code information management module when a network fault occurs.

5. A method for providing a software streaming service in a system including a streaming server for creating an information file about functions being called when respective functions of the implemented application software are used by extracting a function call relation of the application software, creating a function position information file by extracting information arranged in executive codes of the functions, and storing an executive code information file required when the respective functions are used and obtained by integrating the created information and software produced by adding and modularizing codes for a fault tolerance and streaming by functions, and a client composed of an executive code information management module for recording and managing all the executive codes received from the streaming server and a software streaming control module for controlling the executive code information management module when a network fault occurs, the method comprising:
a first step of performing the application software in response to a request for the software streaming service between the client and the streaming server; and
a second step of the client continuously performing the application software in a limited manner using the streamed executive code when the network fault occurs.

6. The method as claimed in claim 5, wherein the first step comprises the steps of:
requesting the software streaming service;
the client confirming whether the corresponding application software executive code information file exists in a client local system, and if the executive code information file does not exist in the local system, receiving information file about the whole executive codes from the streaming server and completing a work for the executive code information file;
the streaming server transmitting a code required for an initial execution to the client; and
starting and using the application software using the received initial executive code.

7. The method as claimed in claim 5, wherein the second step comprises the steps of:
periodically requesting a confirmation of a normal/faulty state of the network to the application software streaming control module; and
if the network state is changed from the normal state to the faulty state, the client collecting information about the executive codes that are not streamed, inactivating the function corresponding to the executive codes that are not streamed, and continuously using the streamed function only in a limited manner.

8. The method as claimed in claim 5, wherein the second step comprises the steps of:
periodically requesting a confirmation of a normal/faulty state of the network to the application software streaming control module;
if the network is in the faulty state, continuously using the application software using a limited function, and
if the network state is changed from the faulty state to the normal state, the client restoring the function of the application software and normally using the restored application software.

9. The method as claimed in claim 5, wherein the first step comprises the steps of:
the client monitoring an executive code request produced by the client during the execution of the software, and judging whether the requested executive code exists in the local computer;
if the requested executive code does not exist in the local computer, searching for the function of the corresponding executive code using the whole information about the executive codes for the streaming of the executive codes by functions;
requesting and receiving the corresponding executive code from the streaming server, executing the software and updating the executive code information; and
repeating the steps of judging the existence/nonexistence of the executive code and searching for the corresponding code function and updating the executive code information.
